(19) United States
(12) Patent Application Publication
(10) Pub. No.: US 2007/0171079 A1
(43) Pub. Date: Jul. 26, 2007

(54) Device with coil antenna

(75) Inventors: Yoshitaka Saito, Sendai-shi (JP); Shigeyoshi Yoshida, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 11/653,885

(22) Filed: Jan. 16, 2007

(30) Foreign Application Priority Data
Jan. 16, 2006 (JP) 2006-007552

(51) Int. Cl. G08B 13/14

(52) U.S. Cl. 340/572.8; 340/572.7

(57) ABSTRACT

A device with a coil antenna is disclosed. The coil antenna defines an aperture. The device further comprises a magnetic flux guide adapted to guide magnetic fluxes so that the guided magnetic fluxes pass through the aperture of the coil antenna. For example, the magnetic flux guide is made of a sheet-shaped magnetic material such as a complex magnetic sheet, which comprises soft magnetic powder particles and a binder agent binding them.

### BACKGROUND OF THE INVENTION

This invention relates to a device with a coil antenna and, in particular, to the device used in a communication apparatus such as a radio frequency identification (RFID) tag or a non-contact or contactless integrated circuit (IC) card.

One semiconductor chip with a coil antenna is disclosed in US2005/0173532A1, the contents of which are incorporated herein by reference. The disclosed semiconductor chip comprises a coil antenna, a transmission/reception circuit and a mechanism for increasing a coupling coefficient in an electromagnetic coupling between the coil antenna and an external device with which the semiconductor chip communicates by the use of the transmission/reception circuit. The exemplary mechanism comprises a magnetic material mounted on the semiconductor chip or plural layers of the coil antenna. The disclosed coil antenna is formed on a silicon wafer of the semiconductor chip with a polyimide layer interposed therebetween.

According to US2005/0173532A1, the size of an inner area or an aperture of the coil antenna depends on the size of the semiconductor chip so that a large inner area or a large aperture cannot be obtained, and the coil antenna cannot provide sufficient electromotive force.

### SUMMARY OF THE INVENTION

It is an object of the present invention to provide a coil-antenna containing device which is able to provide sufficient electromotive force.

According to one aspect of the present invention, a device comprises a semiconductor chip, a coil antenna and a magnetic flux guide. The coil antenna is electrically connected to the semiconductor chip. The coil antenna has a bottom portion and defines an aperture. The magnetic flux guide comprises a first portion and a second portion connected to the first portion. The first portion supports the bottom portion of the coil antenna. The second portion is positioned within or traverses the aperture of the coil antenna.

According to another aspect of the present invention, a device comprises a semiconductor chip, a coil antenna and a magnetic flux guide. The coil antenna is electrically connected to the semiconductor chip and defines an aperture. The magnetic flux guide is designed to guide magnetic fluxes so that the guided magnetic fluxes pass through the aperture of the coil antenna.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a device in accordance with a first embodiment of the present invention;

FIG. 2 is a perspective view showing a semiconductor chip and a coil antenna of FIG. 1;

FIG. 3 is a perspective view showing a magnetic flux guide of FIG. 1;

FIG. 4 is a cross-sectional view showing an application structure including the device of FIG. 1;

FIG. 5 is a perspective view showing a device in accordance with a second embodiment of the present invention;

FIG. 6 is a perspective view showing a magnetic flux guide of FIG. 5;

FIG. 7 is a perspective view showing a non-contact IC card in accordance with a third embodiment of the present invention;

FIG. 8 is a plan view showing a structure of FIG. 7, which includes a semiconductor chip and a coil antenna; and

FIG. 9 is a plan view showing a magnetic flux guide of FIG. 7.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

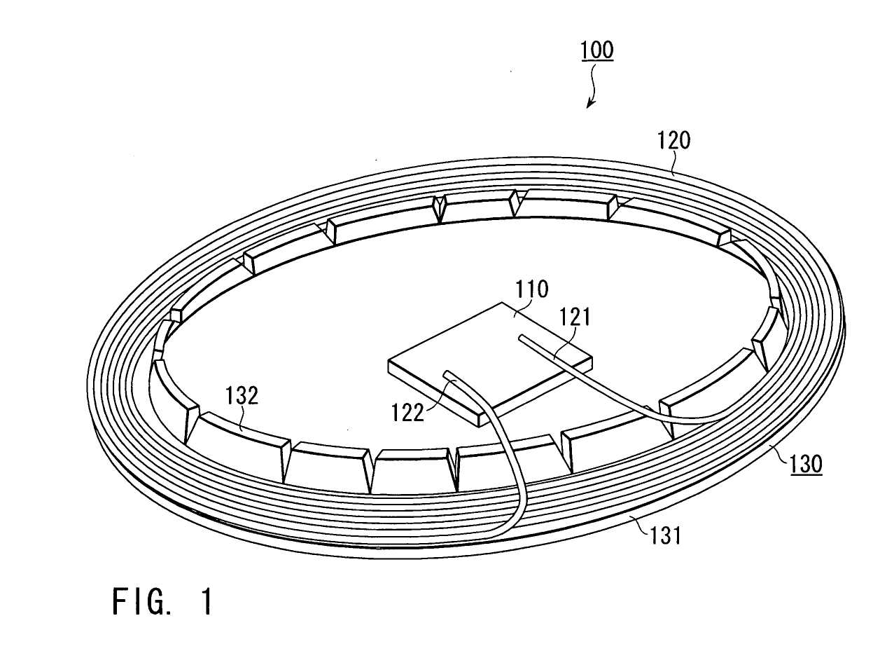

With reference to FIG. 1, a device 100 according to a first embodiment of the present invention comprises a semiconductor chip 110, a coil antenna 120 and a magnetic flux guide 130.

The coil antenna 120 is made of an electrically conductive wire coated with an insulator and is formed by winding the wire. The coil antenna 120 has two ends as leads 121, 122, which are electrically connected to the semiconductor chip 110.

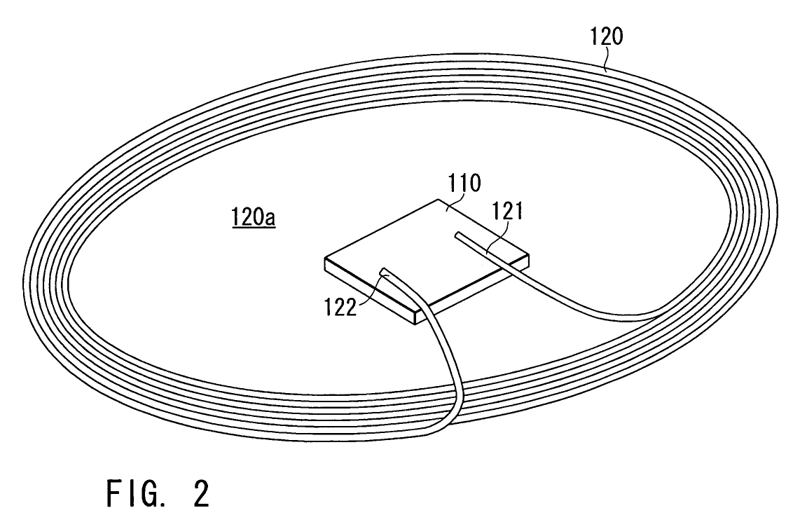

The coil antenna 120 of the present embodiment is made of a single layer flat coil and has a flat annular shape. As shown in FIG. 2, the coil antenna 120 of this embodiment is formed and is electrically connected to the semiconductor chip 110 before the coil antenna is combined with the magnetic flux guide 130. The illustrated coil antenna 120 has a bottom surface and defines an aperture 120a.

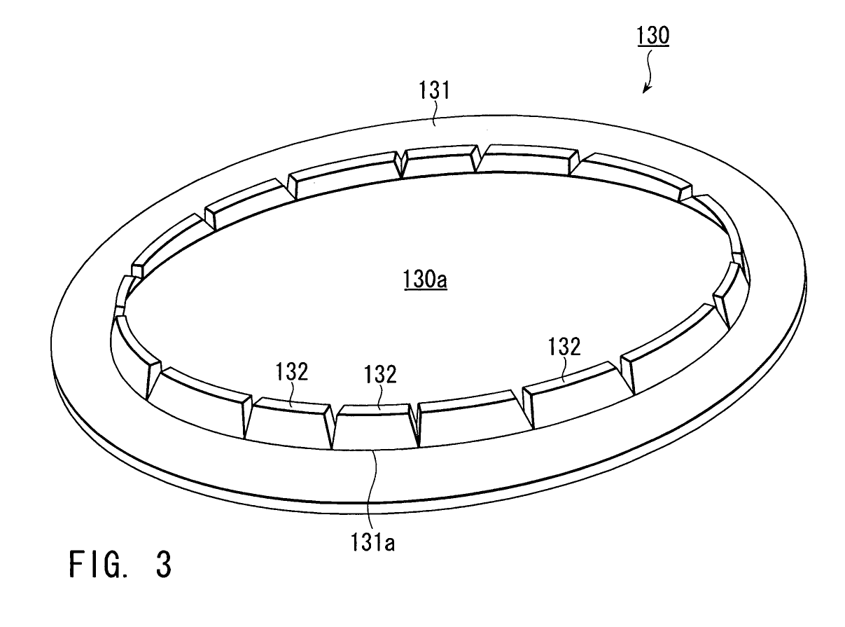

As shown in FIG. 3, the magnetic flux guide 130 comprises a flat portion 131 and a plurality of sub-portions 132. The illustrated flat portion 131 has an inner edge 131a, from which each of the sub-portions 132 extends upwardly. The illustrated flat portion 131 has a flat annular shape so that the sub-portions 132 are arranged on the inner circumference of the flat portion 131.

The magnetic flux guide 130 of the present embodiment is made of a single sheet of complex magnetic substance that comprises soft magnetic powder particles and a binder agent binding them. The complex magnetic sheet is flexible and bendable. The complex magnetic sheet of this embodiment is obtained by mixing Fe—Al—Si alloy powder particles of 83.0 wt % and an organic binding agent of 17.0 wt %, followed by rolling the mixture, wherein the Fe—Al—Si alloy powder particles have an average diameter of 35 μm and are obtained by a bead mill grinding process, the organic binding agent is a thermoplastic elastomer, and the rolled complex magnetic sheet has a thickness of 0.3 mm. Each of the soft magnetic powder particles may have a flat shape and/or may be coated with an insulator layer such as an oxide film. The magnetic flux guide 130 may be made of another magnetic material and or may be formed by laminating two or more magnetic material sheets.

The illustrated magnetic flux guide 130 is formed by stamping out the complex magnetic sheet into a flat annular shape provided with a plurality of radially-extending cuts, followed by pressing it to bend the sub-portions 132 upwardly. The thus formed magnetic flux guide 130 has a guide aperture 130a, which is smaller than the aperture 120a of the coil antenna 120.

As seen from FIGS. 1 to 3, the magnetic flux guide 130 is combined with the coil antenna 120 and the semiconductor chip 110. In detail, the sub-portions 132 of the magnetic flux guide 130 are inserted into the aperture 120a from below the coil antenna 120 so that the sub-portions 132 traverse the aperture 120a while the flat portion 132 receives and supports the bottom surface of the coil antenna 120. To this end, the flat portion 131 of the magnetic flux guide 130 is designed so that the inner edge 131a defines a shape smaller than the aperture 120a of the coil antenna 120.

In this embodiment, each of the sub-portions 132 has a certain height so that the sub-portion 132 traverses the aperture 120a. However, each sub-portion 132 may have a smaller height so that the sub-portion 132 is positioned within the aperture 120a.

The magnetic flux guide 130 guides magnetic fluxes existing below the coil antenna 120 so that the guided magnetic fluxes pass through the aperture 120a of the coil antenna 120. Thus, the magnetic flux guide 130 can increase induced electromagnetic force by the coil antenna 120.

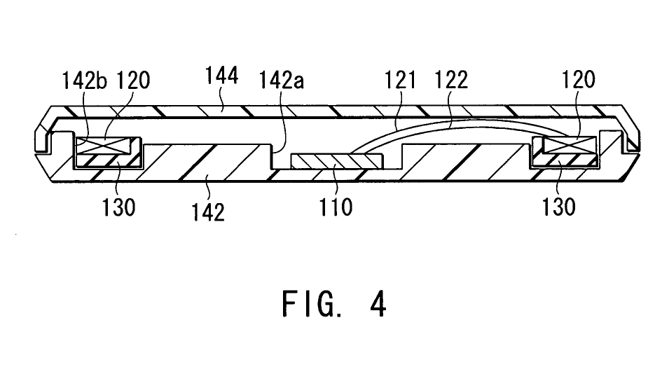

FIG. 4 shows one of applications of the device 100. The application is a structure for RFID tag, which comprises a lower case or base 142 and an upper case or lid 144. The lower case 142 is formed with a disc-shaped depression 142a and an annular recess 142b. The semiconductor chip 110 is arranged within the depression 142a, while the coil antenna 120 and the magnetic flux guide 130 are arranged within the annular recess 142b. The lower and the upper cases 142, 144 define a cavity, which is filled with an epoxy resin. The structure as such may be used as the RFID tag by adding an adhesive agent onto the bottom of the structure, or may be combined with a base sheet made of paper, resin, wood chip, rubber or another material.

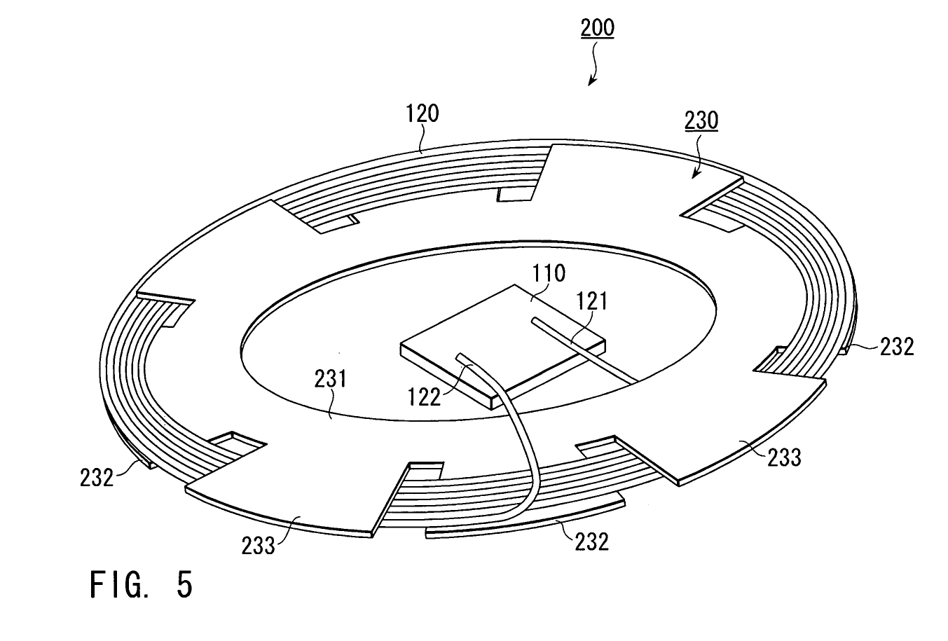

With reference to FIG. 5, another device 200 according to a second embodiment of the present invention comprises a semiconductor chip 110, a coil antenna 120 and a magnetic flux guide 230. The semiconductor chip 110 and the coil antenna 120 are components same as those explained in the first embodiment. Therefore, explanation will be directed to the magnetic flux guide 230 and a method for combining the magnetic flux guide 230 with the semiconductor chip 110 and the coil antenna 120

The magnetic flux guide 230 generally has a gear shape and comprises a base portion 231, a plurality of lower flaps 232, and a plurality of upper flaps 233. The base portion 231 has a flat annular shape, which has an outer circular edge 231a; the outer circular edge 231a defines a circle smaller than the aperture 120a of the coil antenna 120. Each of the lower flaps 232 extends outwardly from the outer edge 231a of the base portion 231 in a radial direction of the base portion 231. Each of the upper flaps also extends outwardly from the outer edge 231a of the base portion 231 in the radial direction. In this embodiment, the lower and the upper flaps 232, 233 are alternately arranged on the periphery of the second portion. In other words, each of the upper flaps 233 is positioned between the neighboring two lower flaps 232 on the periphery of the base portion 231.

The magnetic flux guide 230 is also made of a single sheet of complex magnetic substance that comprises soft magnetic powder particles and a binder agent binding them. The complex magnetic sheet is flexible and bendable. The complex magnetic sheet of this embodiment is obtained by mixing Fe—Al—Si alloy powder particles of 83.0 wt % and an organic binding agent of 17.0 wt %, followed by rolling the mixture, wherein the Fe—Al—Si alloy powder particles have an average diameter of 30 μm and are obtained by a water atomization process, the organic binding agent is a thermoplastic elastomer, and the rolled complex magnetic sheet has a thickness of 0.3 mm. Each of the soft magnetic powder particles may have a flat shape and/or may be coated with an insulator layer such as an oxide film. The magnetic flux guide 230 may be made of another magnetic material and or may be formed by laminating two or more magnetic material sheets. The illustrated magnetic flux guide 230 is formed by stamping out the complex magnetic sheet into the gear shape. The thus formed magnetic flux guide 230 has a guide aperture 230a, which is smaller than the aperture 120a of the coil antenna 120.

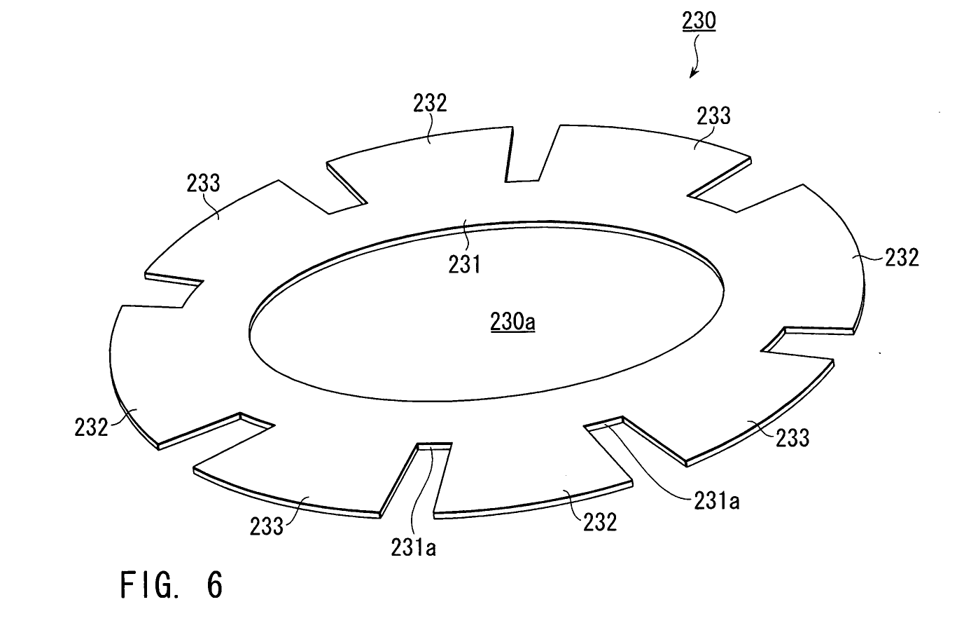

The magnetic flux guide 230 is combined with the coil antenna 120 and the semiconductor chip 110, as explained below with reference to FIGS. 2, 5 and 6. First, the combination of the coil antenna 120 and the semiconductor chip is prepared as shown in FIG. 2. Next, the upper flaps 233 of the magnetic flux guide 230 are temporally bent and forced to stand up vertically. The standing upper flaps 233 are then inserted into the aperture 120a of the coil 120 from below the coil antenna 120 so that the coil antenna 120 is disposed on the lower flaps 232 of the magnetic flux guide 230. To this end, the base portion 231 is designed so that the outer edge 231a defines a shape smaller than the aperture 120a of the coil antenna 120. The inserted upper flaps 233 are bent back so that the lower flaps 232 are brought into contact with the bottom surface of the coil antenna 120 while the upper flaps 233 are brought into contact with the top surface of the coil antenna 120. Thus, the coil antenna 120 is held by the upper and the lower flaps 233, 232 and is positioned therebetween.

Although the magnetic flux guide 230 has a gear shape in this embodiment, this invention is not limited thereto. For example, the magnetic flux guide 230 may have a shape obtained by stamping out a complex magnetic sheet into a flat annular shape, followed by making a plurality of cuts into the flat annular shape of the complex magnetic sheet, wherein each of the cuts extends from an outer edge of the flat annular shape towards a center thereof along a radial direction of the flat annular shape. In addition, the base portion 231 of the magnetic flux guide 230 may have an angular frame shape instead of the annular shape.

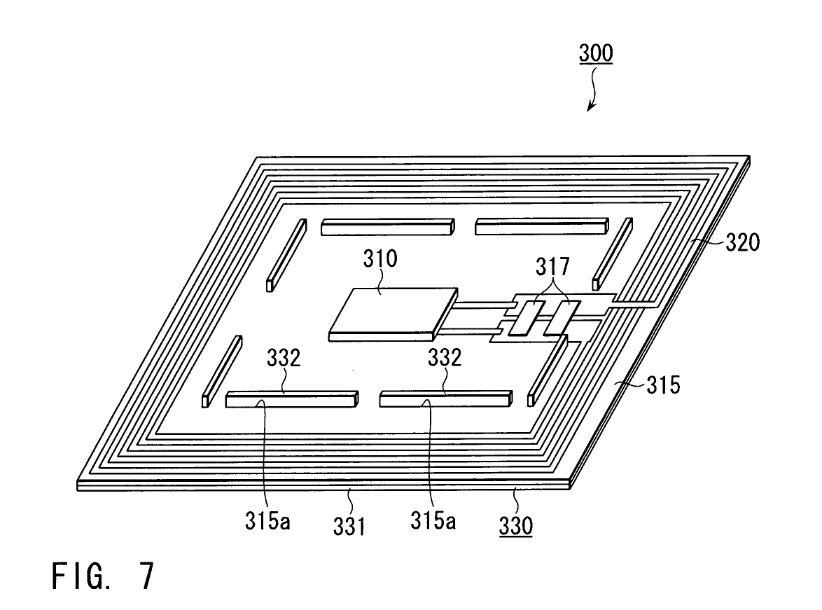

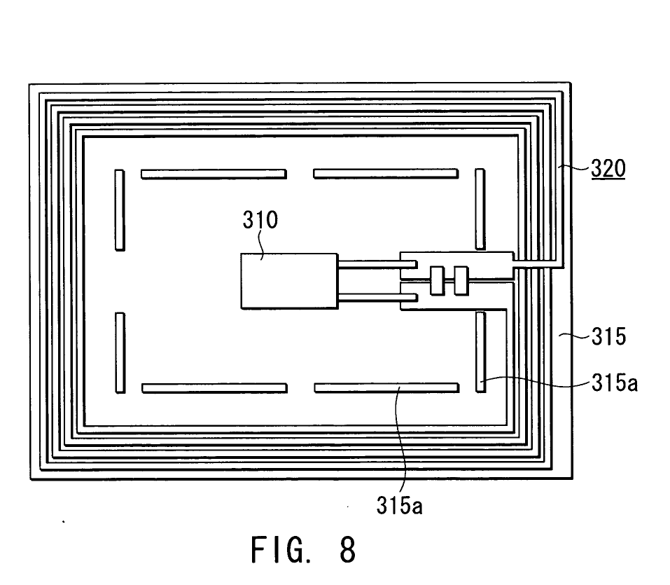

With reference to FIG. 7, a third embodiment of the present invention is directed to a non-contact IC card 300. The IC card 300 is a combination of a structure shown in FIG. 8 and a magnetic flux guide 330.

As shown in FIGS. 7 to 9, the IC card 300 comprises a semiconductor chip 310, a coil antenna 320 and the magnetic flux guide 330.

The coil antenna 320 is formed on a resin substrate 315 by a printing process. The illustrated coil antenna 320 is made of a single layer flat metallic coil. The illustrated semiconductor chip 310 is mounted on the center of the resin substrate 315. The IC card 300 further comprises capacitors 317 for resonance. The resin substrate 315 is provided with a plurality of slits 315a, which are positioned inside the coil antenna 320, as shown in FIGS. 7 and 8.

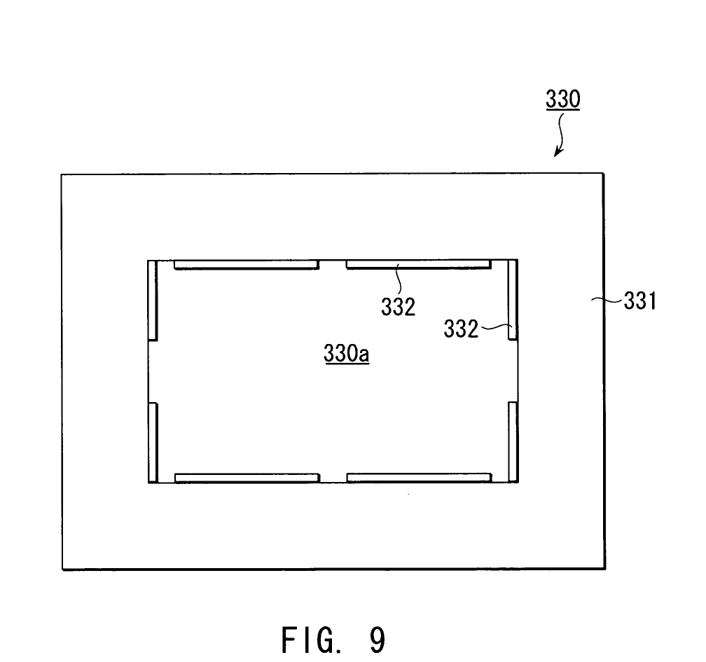

With reference to FIGS. 7 and 9, the magnetic flux guide 330 comprises a flat portion 331 and a plurality of sub-portions 332. The flat portion 331 has an angular frame shape, which has an inner rectangular edge and defines a guide aperture 330a. Each of the sub-portions 332 stands up from the inner rectangular edge of the flat portion 331.

The sub-portions 332 are inserted into the slits 315a, respectively, while the peripheral part of the resin substrate is supported by the flat portion 331 of the magnetic flux guide 330, as best shown in FIG. 7, so that the IC card can be obtained.

The magnetic flux guide 330 also guides magnetic fluxes existing below the resin substrate 315 so that the guided magnetic fluxes pass through the aperture of the coil antenna 320, resulting in increase of induced electromagnetic force by the coil antenna 320.

The present application is based on Japanese patent applications of JP2006-007552 filed before the Japan Patent Office on Jan. 16, 2006, the contents of which are incorporated herein by reference.

While there has been described what is believed to be the preferred embodiment of the invention, those skilled in the art will recognize that other and further modifications may be made thereto without departing from the sprit of the invention, and it is intended to claim all such embodiments that fall within the true scope of the invention.

What is claimed is:

1. A device comprising:
a semiconductor chip;
a coil antenna electrically connected to the semiconductor chip, the coil antenna having a bottom portion and defining an aperture; and
a magnetic flux guide comprising a first portion and a second portion connected to the first portion, the first portion supporting the bottom portion of the coil antenna, the second portion being positioned within or traversing the aperture of the coil antenna.

2. The device according to claim 1, wherein the coil antenna is made of a flat coil.

3. The device according to claim 1, wherein the coil antenna is made of a single layer flat coil.

4. The device according to claim 1, wherein the coil antenna has a flat shape.

5. The device according to claim 4, wherein the flat shape is a flat annular shape.

6. The device according to claim 1, wherein the magnetic flux guide is made of a magnetic material.

7. The device according to claim 6, wherein the magnetic material is a complex magnetic material comprising soft magnetic powder particles and a binder agent binding them.

8. The device according to claim 1, wherein the magnetic flux guide is made of a single magnetic material sheet.

9. The device according to claim 1, wherein the bottom portion defines a flat surface perpendicular to a vertical direction; the first portion has a flat shape having an inner edge, the inner edge defining a shape smaller than the aperture of the coil antenna, the inner edge being positioned within the aperture of the coil antenna as seen along the vertical direction; and the second portion extends from the inner edge of the first portion.

10. The device according to claim 9, wherein the second portion consists of a plurality of sub-portions each extending from the inner edge of the first portion.

11. The device according to claim 1, wherein: the second portion is a base portion having an outer edge, the outer edge of the second portion defining a shape smaller than the aperture of the coil antenna; the first portion consists of two or more lower flaps, each of the lower flaps extending outwardly from the outer edge of the second portion; the magnetic flux guide further comprising a third portion consisting of two or more upper flaps, each of the upper flaps extending outwardly from the outer edge of the second portion; and the lower flaps of the first portion are brought into contact with the bottom portion of the coil antenna while the upper flaps of the third portion are brought into contact with the top portion of the coil antenna so that the coil antenna is held by the first and the third portions and is positioned there between.

12. The device according to claim 11, wherein each of the upper flaps is positioned between neighboring two flaps of the lower flaps on a periphery of the second portion.

13. The device according to claim 1, wherein the second portion has a guide aperture smaller than the aperture of the coil antenna.

14. A device comprising:
a semiconductor chip;
a coil antenna electrically connected to the semiconductor chip, the coil antenna defining an aperture; and
a magnetic flux guide adapted to guide magnetic fluxes so that the guided magnetic fluxes pass through the aperture of the coil antenna.

15. A radio frequency identification tag comprising the device according to claim 1.

16. A non-contact integrated circuit card comprising the device according to claim 1.
